(19) United States
(12) Patent Application Publication
(10) Pub. No.: US 2010/0147705 A1
(43) Pub. Date: Jun. 17, 2010

(54) Amperometric Sensor and Method for the Detection of Gaseous Analytes Comprising A Working Electrode Comprising Edge Plane Pyrolytic Graphite

(75) Inventors: Richard Guy Compton, Oxford (GB); Craig Edward Banks, Oxford (GB)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ISIS INNOVATION LTD., Oxford (GB)

(21) Appl. No.: 11/722,333

(22) PCT Filed: Dec. 22, 2005
(86) PCT No.: PCT/GB05/05047

§ 371 Date: Sep. 1, 2009

(30) Foreign Application Priority Data
Dec. 24, 2004 (GB) 0428283.6
Dec. 24, 2004 (GB) 0428290.1

(51) Int. Cl. G01N 27/26

(52) U.S. Cl. 205/779.5; 204/431; 205/775; 205/781; 205/785.5; 205/780.5; 205/787; 205/786.5

(57) ABSTRACT

An electrochemical sensor and method of detecting gaseous analytes are provided, which involve the use of a working electrode comprising edge plane pyrolytic graphite.

### FIELD OF THE INVENTION

The present invention relates to electrochemical sensors and electrode materials for the detection of gaseous analytes.

### BACKGROUND TO THE INVENTION

The monitoring of reducible and oxidizable gases has become increasingly important as the effects of such gases upon health and the environment have been brought into the public eye. Such gases include nitrogen dioxide (NO₂), chlorine (Cl₂), sulphur dioxide (SO₂), hydrogen (H₂), hydrazine (N₂H₄), arsine (AsH₃), nitrogen monoxide (NO, also referred to as nitric oxide), hydrocarbon (HC), oxygen (O₂), ozone (O₃), carbon monoxide (CO), carbon dioxide (CO₂), hydrogen sulphide (H₂S), methane (CH₄) and carbon disulphide (CS₂). These gases may be toxic and environmental pollutants, being generated, for example, from combustion processes. The gases may be formed from burning fuel in motor vehicles, electric power plants, and other industrial, commercial, and residential sources that burn fuel. They may be present in enclosed spaces such as ice rinks from ice surface renewal machines and in kitchens or apartments from using a gas stove. Exposure to some reducible and oxidizable gases may exacerbate a pre-existing pathogenic condition in people who spend a large amount of time in such places and/or cause respiratory health problems. Consequently, continuous monitoring is required.

Known methods of gas detection include, for example, chemiluminescence, fluorometric and spectrophotometric analysis. Chlorine, for example, is a highly toxic gas which is used in many commercial applications, and spectroscopic techniques are frequently applied for chlorine detection. Methods include X-ray fluorescence, fibre optic fluorescence sensing and atomic emission spectrometry. Also utilised is the optical response of a Zn porphyrin dimer to gaseous chlorine, although a more common colorimetric technique for sensing chlorine employs the redox reaction of N,N-diethyl-p-phenylenediamine (DEPD) to produce a strong red colour. Other chromogenic reagents used for chlorine detection include o-toluidine and 4-nitrophenylhydrazine.

A favoured alternative utilises electrochemical sensors, which are preferred due to their low cost, simplicity and ability to be integrated into portable units. Nafion-backed porous gold electrodes, multi-walled carbon nanotubes coated with tin oxide, polypyrole-nanotube composites and semi-conductor sensors (e.g. tin oxide thin films) have all been reported for the detection of reducible and oxidizable gases.

Electrochemical sensors are based upon the configuration of an electrochemical cell, with an electrolyte and at least two electrodes on either side of the electrolyte, for example. In potentiometric measurements, there is no current passing through the cell, and these two electrodes are sufficient. A signal is measured as the potential difference (voltage) between the two electrodes.

Amperometric sensors are also a type of electrochemical sensor, in which measurements are made be monitoring the current in the electrochemical cell between a working electrode (also called a sensing electrode) and a counter electrode (also called an auxiliary electrode) at a certain potential (voltage). These two electrodes are separated by the electrolyte. A current is produced when the sensor is exposed to a gas containing an electroactive compound (analyte) because the analyte reacts within the sensor, either producing or consuming electrons (e). That is, the analyte is oxidized or reduced at the working electrode. If both oxidation and reduction occur, this is referred to as a redox reaction. The oxidation or reduction of the analyte will cause a change in current between the working and counter electrodes, which will be related to the concentration of the analyte. Complimentary chemical reactions will occur at each of the working electrode and counter electrode. These reactions can be accelerated by an electrocatalyst, such as a platinum electrode or another material on the surface of the electrodes, or can be a sacrificial electrode process in which the electrode material is consumed, for example with Ag/AgCl electrodes. When amperometric sensors are used in a cyclic voltammetry experiment, an external potential is applied to the cell, and the current response is measured. Precise control of the external applied potential is required, but this is generally not possible with a two electrode system, due to the potential drop across the cell due to the solution resistance and the polarization of the counter electrode that is required to complete the current measuring circuit. Better potential control is achieved using a potentiostat and a three-electrode system, in which the potential of one electrode (the working electrode) is controlled relative to the reference electrode, and the current passes between the working electrode and the third electrode (the counter electrode).

Electrochemical techniques for the quantification of chlorine have been described. Almost invariably, these employ noble metal or modified working electrodes. A review of chlorine detection has been published by B. J. Hemlem et al (J. Am. Wafer. Works. Assoc. 2000, 92, 101) which examined the electrochemical basis of amperometric and potentiometric methods. It was concluded that amperometric methods are superior to potentiometric endpoint detection due to simplicity and sensitivity. Flow-injection amperometry utilising two polarized platinum electrodes has been reported by W. Matuszewski et al (Analytica Chimica Acta 1988, 207, 59) which is based on the oxidation of iodide by chlorine. Furthermore, the quantification of chlorine through the amperometry detection of oxygen released from the reaction of chlorine with hydrogen peroxide has been demonstrated by J. T. Coburn et al (Water Chlorination: Environ. Impact Health Eff. 1983, 4, 743). Recently Seymour et al (Electroanalysis 2003, 15, 689) reported on the in-direct analysis of chlorine which involves reduction with N,N-diethyl-p-phenylenediamine with monitoring of the latter providing improved sensitivity and selectivity.

The choice of suitable sensor arrangement and materials is vital when considering the gas to be sensed; temperature range and electrochemical method to be used. Amperometric sensors have been found to enable low cost of components, small size, and lower power consumption than other types of sensor, and are ideal for use in portable analysis systems.

Stretter et al (J. Electrochem. Soc. 2004, 151, H75 and J. Electrochem. Soc. 2003, 150, H272) describe the amperometric detection of nitrogen monoxide and nitrogen dioxide using gold film electrodes. However, the cost of such electrodes may preclude their use in commercial sensors. Also, the use of gold electrodes with sulphuric acid electrolyte is known to have a large, irreversible polarization of the gold counter electrode during detection which causes sluggish response characteristics.

An alternative method involves the use of carbon-based electrodes, which are widely employed in electroanalysis due to their low background currents, wide potential windows and low cost. In particular, carbon is an attractive material from which to manufacture electrodes since it is inexpensive in comparison to materials such as platinum or gold, it is relatively chemically inert in most electrolyte solutions and retains a high surface activity.

A gas sensor comprising a graphite working electrode is described in U.S. Pat. No. 4,265,714, in which a hydrated, solid polymer electrolyte is used in combination with an improved electrode as part of an electrochemical cell. Cell arrangements are described which can detect reducible gases such as chlorine and nitrogen dioxide as well as oxidizable gases such as nitric oxide. However, this type of electrode material is primarily designed to be used with solid polymer electrolytes only. Moreover, no non-empirical basis is presented for developing or increasing any catalytic activity of the graphite or for predicting any catalytic activity in respect of gas such as chlorine.

An edge plane pyrolytic graphite (eppg) working electrode has been disclosed for the detection of thiols (R. R. Moore et al, Analyst, 2004, 129, 755-758).

There remains a need for electrode materials for electrochemical gas sensors which have improved characteristics over the materials described above.

### SUMMARY OF THE INVENTION

The present invention is based on the discovery that at least some of the limitations of conventional electrochemical gas sensors can be overcome by using working electrodes comprising edge plane pyrolytic graphite.

Accordingly, a first aspect of the present invention is an electrochemical sensor for the detection of a gaseous analyte in a sample, wherein the sensor comprises working and counter electrodes, and wherein the working electrode comprises edge plane pyrolytic graphite.

The edge plane pyrolytic graphite is preferably present in an amount sufficient to provide an electrochemically significant proportion of edge plane sites.

The sensor may further comprise an electrolyte in contact with the electrodes. The sensor may also comprise a reference electrode in contact with the electrolyte. The working electrode may be disposed on one side of the electrolyte and a counter electrode disposed on the opposite side of the electrolyte to the working electrode.

In one embodiment, the sensor is an amperometric type gas sensor.

The working electrode may comprise a mixture of edge plane pyrolitic graphite (eppg) and basal plane pyrolitic graphite (bppg).

The amount of edge plane pyrolitic graphite may be greater than that present in regular graphite. The amount of eppg may be only a few percent more than that in regular graphite. As an alternative, however, the graphite may be spherical graphite in which approximately 50% of the edge plane sites are provided by eppg.

As a further alternative, the graphite may be an aligned single crystal in which substantially all (i.e. about 100%) of the sites are eppg.

The sensor may include a detector for measuring an electrical characteristic generated by the electrochemical cell.

The working electrode may be selected so as to undergo a reduction/oxidation reaction upon contacting the analyte.

The working electrode may exhibit an electrical response when exposed to the analyte, the electrical response being proportional to the amount of electrochemically reducible or oxidizable gas.

The sensor may further include an inlet for a sample, which is usually a gaseous sample. A filter may be provided between the gas inlet and the working electrode.

A porous membrane may be provided between the gas inlet and the working electrode allowing diffusion of the electrochemically reducible or oxidizable gas to the working electrode. The electrode may be comprised on a surface of the porous membrane.

A second aspect of the present invention is a method of detecting a gaseous analyte in a sample, which comprises the steps of contacting the sample with a working electrode of an electrochemical sensor of the invention and determining the electrochemical response of the working electrode to the sample.

The analyte may be nitrogen dioxide, chlorine, sulphur dioxide, hydrogen, hydrazine, arsine, nitrogen monoxide, a hydrocarbon, oxygen, ozone, carbon monoxide, carbon dioxide, hydrogen sulphide, methane or carbon disulphide. In a particular embodiment, the analyte is nitrogen dioxide.

The method may further comprise maintaining the working electrode at a constant applied voltage.

The current flow may be measured between the working electrode and the counter electrode to determine the amount of gas.

The gaseous sample is preferably filtered for the removal of any unwanted gases which may cause a substantial current flow between the working electrode and the counter electrode and the counter electrode at the same constant voltage applied to the working electrode as the electrochemically reducible or oxidizable gas. Preferably, the sample is filtered before it reaches the working electrode.

Further aspects of the invention concern a working electrode comprising edge plane pyrolytic graphite and its use in the detection of gaseous analytes.

A sensor of the present invention may have an improved sensitivity, reliability or lifetime with respect to conventional sensors. In particular, this may be attributable to superior sensing characteristics of the eppg working electrode material. The edge plane pyrolytic graphite may produce an excellent voltammetric signal in comparison with other carbon-based electrodes, exhibiting a well-defined, analytically useful voltammetric redox couple, which can be used in the amperometric gas sensing of reducible and oxidizable gases, and which is absent in other electrode materials. By appropriate selection of materials, a sensor which alleviates some or all of the problems associated with known sensors may be provided. The overall cost of the sensor may also be reduced since an electrocatalyst may not be required at the electrodes.

### BRIEF DESCRIPTION OF THE DRAWINGS

FIG. 1 shows the oxidation of chloride at (a) a boron-doped diamond electrode and (b) an edge plane pyrolytic graphite, both in a solution of 0.05M NaCl in 0.1M HNO₃ and recorded at 100 mVs⁻¹ vs. SCE.

FIG. 2 shows cyclic voltammograms for the reduction of chlorine in a 0.1 M nitric acid solution using edge plane pyrolytic graphite, glassy carbon, basal plane pyrolytic graphite and boron-doped diamond electrodes, recorded at 100 mVs⁻¹ vs. SCE.

FIG. 3 shows an edge plane pyrolytic graphite electrode in a 0.1 M nitric acid solution saturated with Cl₂ with increasing scan rates of 100, 200, 500, 750, 1000, 1500, 2000 mVs⁻¹, all vs. SCE.

FIG. 4 shows cyclic voltammograms of basal plane pyrolytic graphite electrode in a 0.1 M nitric acid solution after normal polishing (A) and an extra 30 seconds (B) and 60 seconds (C), all scans recorded at 100 mVs⁻¹.

FIG. 5 shows a plot of expected peak currents (squares) from calculated equilibrium with experimentally observed peak currents (diamonds) as a function of added chloride.

FIG. 6 comprises two graphs and compares the response of an edge plane pyrolytic graphite electrode with glassy carbon and boron-doped diamond electrodes in a ‘small amount’ of chlorine in a 1 M nitric acid solution, all scans recorded at 100 mVs⁻¹ vs. SCE.

FIG. 7 shows a cyclic voltammogram (faint line) for the reduction of nitrogen dioxide in a 5.0 M sulphuric acid solution using an edge plane pyrolytic graphite electrode, and the same cyclic voltammogram scan (bold line) in the absence of nitrogen dioxide, both recorded at 100 mVs⁻¹ vs. graphite.

FIG. 8 shows cyclic voltammograms recorded at scan rates of 10, 50, 75, 100, 150, 200 mVs⁻¹ using the edge plane pyrolytic graphite electrode (vs. graphite) in 5.0 M sulphuric acid.

FIG. 9 shows cyclic voltammograms of nitrogen dioxide in (A) 0.1 M, (B) 1.0 M and (C) 2.5 M sulphuric acid solution using an edge plane pyrolytic graphite, all recorded at 100 mVs⁻¹ vs. graphite.

FIG. 10 shows (A) cyclic voltammograms of nitrogen dioxide in 5.0 M sulphuric acid solution using a glassy carbon, basal plane pyrolytic graphite and boron-doped diamond electrodes and (B) the same cyclic voltammogram scans in the absence of nitrogen dioxide, all recorded at 100 mVs⁻¹ vs. graphite.

### DESCRIPTION OF VARIOUS EMBODIMENTS

Various embodiments of the present invention will now be explained with reference to the accompanying drawings. It will be apparent to those skilled in the art from this disclosure that the following description of the embodiments of the present invention is provided for illustration only and not for the purpose of limiting the invention as defined by the appended claims and their equivalents.

Electrochemical sensors typically comprise at least two electrodes (the working electrode and the counter electrode) and an electrolyte, though the number of possible arrangements of these components is high. See, for example, Cao et al (Electroanalysis 4 (1992) 253-266), which describes the general configuration of amperometric sensors; the contents of this publication are incorporated herein by reference.

The overall configuration of the electrochemical sensor is not critical to the present invention, as long as it comprises a working electrode of the material described herein. The following sensor designs are given for the purpose of illustrating the invention and should not be construed as limiting.

The electrodes are chosen so as to cause an electrical signal which is related to the concentration (partial pressure) of the analyte gas. In an amperometric sensor, this is realized by a change in current which arises directly from the oxidation or reduction of the analyte. The counter electrode performs a half cell reaction which is in opposition to the working electrode reaction, in order to minimise net chemical changes in the sensor. The working electrode is selected so as to undergo a reduction/oxidation reaction upon contacting the analyte. The working electrode exhibits an electrical response when exposed to the analyte, the electrical response being proportional to the amount of analyte. The electrodes may be provided in any manner in which both electrodes are in contact with the electrolyte. Or, the electrodes may be provided such that the working electrode is disposed on one side of the electrolyte and the counter electrode is disposed on the opposite side of the electrolyte to the working electrode. The electrodes may be affixed to the electrolyte in any manner known in the art, such as bonding or using elastic force.

A working electrode acts as a source or sink of electrons for exchange with molecules in the interfacial region (the material adjacent to the electrode surface), and must be an electronic conductor. It must also be electrochemically inert (i.e., does not generate a current in response to an applied potential) over a wide potential range (the potential window). Commonly used working electrode materials for cyclic voltammetry include platinum, gold, mercury, and glassy carbon. Other materials (for example semiconductors and other metals) are also used, for more specific applications. The choice of material depends upon the potential window required (e.g., mercury can only be used for negative potentials, due to oxidation of mercury at more positive potentials), as well as the rate of electron transfer (slow electron transfer kinetics can affect the reversibility of redox behaviour of the system under study). The rate of electron transfer can vary considerably from one material to another, even for the same analyte, due to, for example, catalytic interactions between the analyte and active species on the electrode surface.

For gas detection, the working electrode is often porous to allow the efficient diffusion of the analyte into the electrolyte. The response of a gas sensor is generally based upon migration of the analyte to the working electrode, the actual electrochemical reaction, and purging of the electrochemical product from the working electrode surface.

The use of carbon electrodes is encouraged by their low cost and convenience of fabrication. By way of example, a carbon electrode may comprise pyrolytic graphite. This material contains both edge plane and basal plane graphite, with the basal:edge ratio and graphite monocrystal size depending on the quality of the pyrolytic graphite used. For large varieties of redox couples, electron transfer rate constants at basal plane graphite have been found to be over 10³ times slower than that for edge plane graphite.

A regular graphite powder contains a mixture of eppg and bppg on the electrode surface. However, if the proportion of edge plane content is increased and used as the working electrode of an electrochemical sensor, then the sensor performance may improve. A particularly desirable response may be obtained when an electrochemically significant amount of edge plane sites are present.

For the electrochemical sensor of the present invention, the content of eppg in a graphite powder mixture may be a few percent or more. For example, the content of eppg in a graphite powder mixture may be at least 50%, more particularly more than 50% (e.g. at least 55%), more particularly at least 60%, at least 65%, at least 70%, at least 75%, at least 80%, at least 85%, at least 90% or at least 95%. The content of eppg and bppg in a graphite mixture can be determined from scanning electron microscopy, scanning probe microscopy or scanning tunneling microscopy.

The working electrode may comprise spherical graphite, which typically provides 50:50 edge plane:basal plane sites.

An aligned single crystal of eppg (i.e. substantially 100% eppg) can also be used as the working electrode of an electrochemical sensor.

For reasons of cost, a graphite powder mixture may be preferable.

The material of the counter electrode may be any material that is suitable for use with the working electrode and chosen electrolyte material in the environment in which the sensor will be used. For, example, the material of the counter electrode may be platinum, graphite or another material generally known for use in counter electrodes, and can be suitably selected by one skilled in the art. The amount of material used for the electrodes is not critical, and may be determined by one skilled in the art, the quantity being high enough to undergo the necessary electrochemical reactions and enabling the user to physically handle the electrodes as necessary.

The gas sensor may additionally include a reference electrode. The reference electrode is provided in or contacting the electrolyte. It is used to maintain the working electrode at a known potential. The major requirement for a reference electrode is that the potential does not change with time. Since the passage of current through an electrode can alter the potential, this is minimized for the reference electrode in the three-electrode system by having a high input impedance for the reference electrode (thereby decreasing the current passing through the reference electrode to negligible levels) and by using a non-polarizable electrode as the reference electrode (i.e., the passage of small currents does not alter the potential).

The electrolyte functions to carry the ionic current (the electrons), solubilise the analyte, support the reactions at the working electrode and counter electrode, and form a stable reference potential with the reference electrode. It must be electrochemically inert, chemically inert to the analyte and have good ionic conductivity.

The material of the electrolyte may be any material that is suitable for use with the working electrode in the environment in which the sensor will be used. For, example, the material of the electrolyte may be a liquid electrolyte, such as sulphuric acid or perchloric acid, or a solid electrolyte, such as Nafion®, zirconia or a polymer; or another material generally known for use in electrolytes; and can be suitably selected by one skilled in the art.

The sensor may also include a detector for measuring an electrical characteristic generated by the electrochemical cell. This may be a potentiostat including a control, amplification and readout circuit which is used to make measurements of the change in current flowing between the working electrode and counter electrode.

The potentiostat is used with a three-electrode sensor, that is, with a sensor also including a reference electrode. The potentiostat provides a fixed or controlled potential for the working electrode relative to the reference electrode. The potentiostat may be used to apply a voltage bias to the working electrode and control the electrochemical cell as well as to convert the sensor's current signal to a voltage signal.

The sample may be a gaseous or liquid sample, but is usually a gaseous sample. Thus, a mechanism may be required to transport gas to and from the sensor. The sensor may include gas inlet and gas outlet to provide gas to the sensor and remove gas from the sensor. This may be a pump, diffusion tube or a pneumatic system, for example. On the other hand, the gas to be measured may simple diffuse from the atmosphere to the working electrode without requiring any particular mechanism.

A filter may be provided at a point between the incoming gas and the working electrode, to remove unwanted particles from the gas stream. Or the filter may be used to improve the selectivity of the sensor by selectively removing unwanted electroactive interfering gases or chemically reacting with the analyte to change the chemical form of the analyte.

Also, there may be provided a porous membrane (or frit) at a point between the incoming gas and the working electrode, which allows diffusion of the analyte to the working electrode, but provides a barrier to prevent leakage of electrolyte from the interior of the sensor. The porous membrane may also act to provide structural support for the sensor assembly and the working electrode may be physically attached to the inner wall of the porous membrane surface.

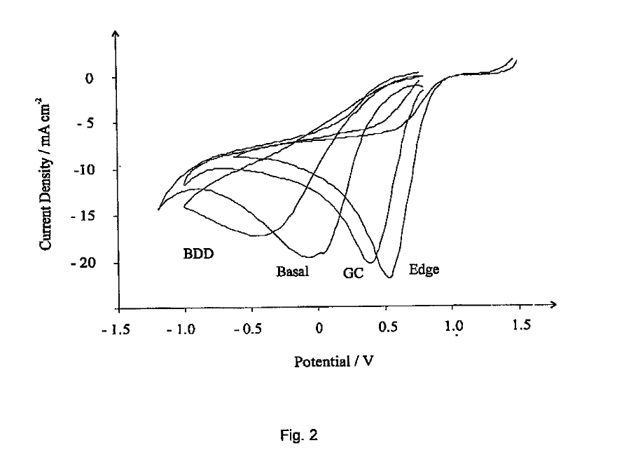

A particular electrochemical sensor design suitable for use in the present invention is shown in FIG. 2 of Cao et al supra, the contents of which are incorporated herein by reference. The sensor comprises a working electrode, a reference electrode, a counter electrode and an electrolyte chamber 4 (including an electrolyte path) which form the basis of the sensor. The sensor further includes an exposure cap, to protect and support the electrodes; a wick separator, to insulate the working electrode from the reference electrode and counter electrode but allow electrochemical contact between the electrodes; a hydrophilic wick; an end cap, including a vent to balance any pressure difference between the inner and outer spaces of the sensor; and a connector for allowing connection of electrical leads to the electrodes.

Alternatively, the electrochemical sensors described by Stetter et al (J. Electrochemical Soc. 150(2) S11-S16, 2003), in particular those of FIG. 2d and FIG. 2f, may be employed in the present invention. The contents of this publication are incorporated herein by reference.

By way of example, a method for detecting a gaseous analyte, for example NO₂, using a sensor of the invention is described below.

An electrochemical gas sensor is assembled, including a working electrode comprising eppg, with electrolyte and counter electrode, as previously described. Cyclic voltammetry is carried out and voltammetric measurements are recorded showing the response of the eppg working electrode to the oxidation/reduction of the analyte gas. A μ-Autolab II potentiostat, for example, may be employed. Specifically, cyclic voltammetry traces the transfer of electrons during an oxidation/reduction reaction. The reaction begins at a certain fixed potential (voltage), and as the potential changes, it controls the point at which the redox reaction will take place. The fixed potential may, for example, be in the range 0.6 to 1.5 V, depending upon the experimental conditions. At the negative electrode, electrons are emitted and reduction occurs. At the positive electrode, the excess electrons are collected, and oxidation occurs. This emitting and collecting of electrons creates a current. The current of the electrochemical cell is measured as a function of potential. The potential is linearly cycled from a starting potential to a final potential and then back to the starting potential. This process cycles the redox reaction. At the initial potential, no reduction or oxidation can occur, but at a certain potential the analyte begins to be reduced. In the reverse potential scan direction, oxidation will occur. Potential versus current is monitored over time, over a range of scan rates. The potential versus the current is plotted as a voltammogram.

Prior to use, gas sensors may require an “equilibration” period before use thereof to provide an adequately stable and low baseline. During this period, the sensor is kept at ambient conditions, at operating potential (preferably zero Volts), for a predetermined amount of time. Then, the response of the sensor to addition of varying concentrations of the analyte gas is examined.

The flow rate of the gas sample is not critical to the present invention and can be determined by one skilled in the art. When testing the sensor, varying concentrations of analyte gas may be controlled by mixing the analyte gas with another gas and changing the flow rates of each gas, while maintaining a fixed total flow rate. The generally preferred range of flow rate is between about 30 and 250 cc per minute.

With a fixed scan rate, variation in the cyclic voltammetric current is typically analyzed as a function of the analyte, and the voltammetric response is plotted.

Variation in the cyclic voltammetric current can be analyzed as a function of the concentration of the analyte gas. A linear response generally results, though any relationship can be later used to predict the analyte concentration with such a sensor cell arrangement. That is, it will be clear to one skilled in the art that in further sensor measurements, the concentration of the analyte gas can be calculated from the current produced by the sensor, in consideration of the relationship calculated between the analyte gas concentration and current.

Electrochemical mechanisms concerning the movement of the analyte through the working electrode and the electrolyte and the movement of electrons are well known in the art. A general description can be found by Cao et at (Electroanalysis 4 (1992) 253-266).

The following Examples illustrate the invention.

In the Examples, eppg (Le Carbone, Ltd), bppg (Le Carbone, Ltd.), GC (3 mm diameter BAS Technicol) and BDD (3 mm diameter, Windsor Scientific Ltd.) electrodes were tested as working electrodes. Disks of eppg and bppg were machined to a 4.9 mm diameter, which was orientated with the disk face parallel with the edge plane, or basal plane, as required. The counter electrode was a bright platinum wire, with saturated calomel as a pseudo-reference electrode (hereinafter referred to as SCE). The GC electrode was polished using diamond pastes of decreasing sizes (Kemet), while the eppg electrode and BDD electrodes were polished on alumina lapping compounds (BDH) of decreasing sizes (0.1-5 μm) on soft lapping pads. The bppg electrode was prepared by renewing the electrode surface with sticky tape. This procedure involved polishing the bppg electrode surface on carborundum paper and then pressing sticky tape on the cleaned bppg surface before removing along with general attached graphite layers. This was repeated several times. The electrode was then cleaned in acetone to remove any adhesive. All chemicals used were of analytical grade and used as received without any further purification.

In all experiments, solutions were first purged with nitrogen gas to remove any oxygen present.

### Example 1

### Detection of Chloride

The sensing characteristics of an edge plane pyrolytic graphite (eppg) electrode were compared with other carbon-based electrode materials, namely boron-doped diamond (BDD), basal plane pyrolytic graphite (bppg) and glassy carbon (GC) electrodes. This was achieved by carrying out voltammetric measurements using a μ-Autolab II potentiostat (ECO-Chemie, The Netherlands) with a three electrode configuration.

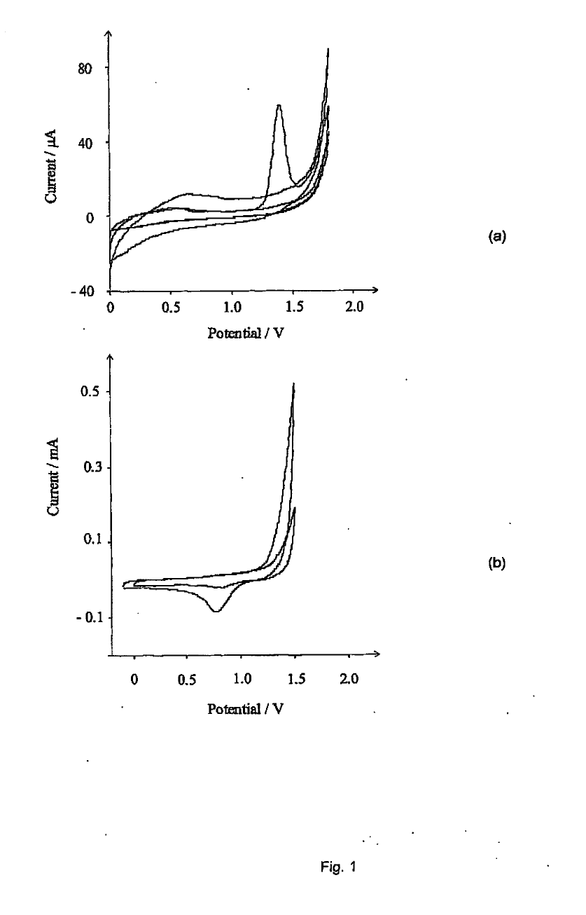

First, the electrochemical oxidation of chloride in aqueous media was considered. FIG. 1 (a) shows the current-voltage voltammetric response when a freshly polished BDD electrode in a solution of 0.05M NaCl in 0.1M HNO₃ was scanned from 0.0 V up to the on-set of solvent breakdown. A single wave is observed at +1.4 V (with a saturated calomel electrode, hereinafter referred to as “vs. SCE”), which disappears on subsequent scans. A reproducible signal was found to occur only when the electrode had undergone a rigorous polishing regime. This involved polishing the electrode before each voltammetric scan with diamond lapping compounds for 30 seconds with 6 micron sized grit, followed by 60 seconds with 1 micron diamond spray. Using the same solution composition as described above, the pre-treatment potential was explored using a fixed pre-treatment time. The magnitude of the voltammetric curve was found to reach a maximum around −1.6 V before the onset of bubble formation. Using a pre-treatment potential of −1.6 V, the duration for which this potential is applied was investigated. It was found that using a longer time than 60 seconds was ineffective in increasing the size of the voltammetric curve. The oxidation wave seen at +1.4 V can be inferred to correspond to the electrochemical oxidation of chloride to chlorine. No corresponding reduction wave was observed on the cathodic scan at this chloride concentration.

Next, the possible analytical use of BDD for the detection of chloride was investigated. Additions of chloride to a 0.1 M nitric acid solution were made, taking care that between each addition the electrode was polished as discussed above. Analysis of the voltammetric wave versus added chloride was found to be linear over the range 40 to 250 μM. This lowest addition was the smallest that could be observed. Furthermore, the sensitivity of the BDD and the required cleaning regime dictated that the applicability of BDD as a sensor for chloride was limited.

FIG. 1 (b) shows the response of an eppg electrode which was investigated in a 0.05 M NaCl in 0.1 M nitric acid solution. No wave is observed on the anodic scan but a reduction wave is clearly evident at ca. +0.74 V (vs. SCE). It is clear that the oxidation of chloride to chlorine is outside the solvent window of the edge plane, but the potential is swept greater than the standard formal potential of chloride to chlorine as evidenced by the corresponding reduction wave at +0.74 V which is likely due to the reduction of chlorine.

Investigating the reduction of chlorine further, FIG. 2 shows the cyclic voltammetric response of an eppg electrode in a 0.1 M nitric acid solution saturated with chlorine. A large reduction wave observed with a peak potential at ca. +0.52 V (vs. SCE). For comparison, the corresponding responses using a GC, a BDD and a bppg electrode were also investigated. The reduction wave occurs with a peak potential at +0.38 V using the GC electrode, while the bppg and BDD electrodes exhibit waves with peak potentials at −0.08 V and −0.45 V respectively.

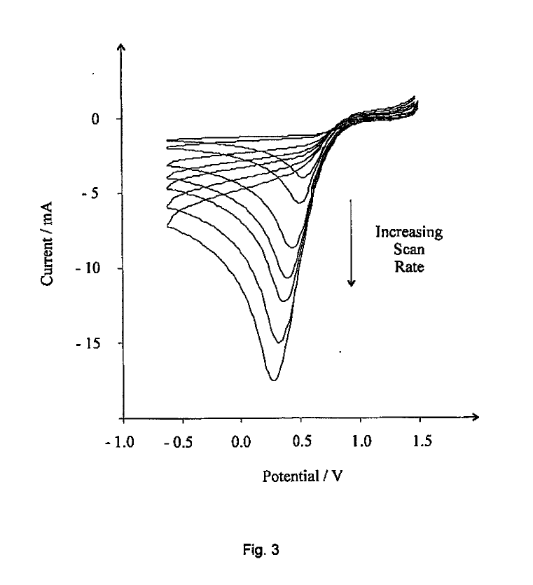

FIG. 3 shows the effect of scan rate on the reduction peak for the eppg electrode. A plot of the reduction peak current versus square root of scan rate produced a linear response indicating a diffusing species rather than an adsorbed one. Next, the effect of increasing the scan rate on the peak potential was varied in-turn for each electrode material. For each electrode a plot of peak potential vs. square root of scan rate was constructed, where the gradient gives an indication of the electrochemical reversibility (the larger the gradient, the higher the degree of irreversibility). Analysis of the gradient for each plot produced a gradient of −7.5×10⁻³ V^{1/2}S^{-1/2} for eppg, −9.5×10⁻³ V^{1/2}S^{-1/2} for GC, −1.42×10⁻² V^{1/2}S^{-1/2} for bppg and −2.14×10⁻² V^{1/2}S^{-1/2} for BDD. These gradients reveal that eppg electrode exhibits an increase in reversibility in comparison to that seen with the other carbon based electrodes studied.

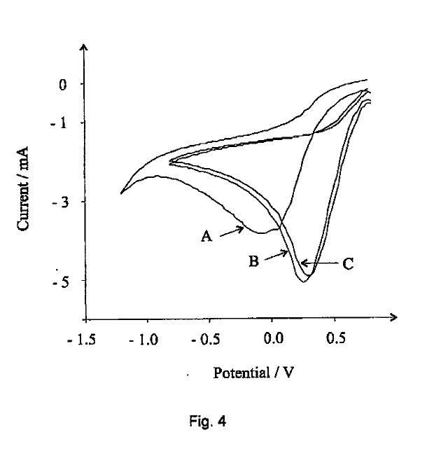

Comparison of all four electrodes (as shown in FIG. 2) along with the increase in electrochemical reactivity suggests that edge plane sites are electro-catalytically active sites for chlorine reduction. To further support this FIG. 4 shows the response when exposing more edge plane sites on the bppg electrode via roughening the electrode surface. Initial routine renewing of the electrode surfaces (response A) produced a peak at −0.08 V, which after roughening with a 0.1 micron alumina slurry for 30 and BO seconds, shifted the voltammetric wave to +0.24 V and +0.29 V respectively (responses B and C). Note that the higher reactivity of the GC electrode is possibly linked to surface oxidation, since the scan is started at high electrochemical potentials where quinone-type functional groups are introduced.

Next, the effect of pH on the voltammetric response of the eppg working electrode was investigated. Solutions of 0.01, 0.1 and 1 M nitric acid solutions were prepared with each one in turn saturated with chlorine and the response of the eppg electrode studied. For 0.01, 0.1 or 1 M nitric acid concentration the voltammetric wave for the reduction of chlorine was observed at ca. +0.30 V, +0.40 V or +0.41 V respectively. Furthermore, the voltammetric wave decreased in magnitude as the acid concentration was increased. The reduction wave observed at +0.40 V (vs. SCE) in 1 M nitric acid is 1-0.64 V (vs. normal hydrogen electrode (NHE). This is considerably cathodic in comparison with the reported standard electrode potential of +1.39 V (vs. NHE) of A. J. Bard et al (Eds. Standard Potentials in Aqueous Solution.; Marcel Dekker, Inc., New York, N.Y., 1985) indicating the considerable irreversibility of the chlorine/chloride couple.

To confirm the above assignments to the reduction of chlorine the speciation of chlorine in aqueous acidic solution was considered. It is known that the electrochemical reduction of chlorine can proceed via the following equation.

Cl₂+2e⁻→2Cl⁻ E^{o}=1.396 V (vs. NHE) (1)

However, chlorine can also undergo the following disproportionation reaction in homogeneous solution as described by the following equation.

Cl₂+H₂O→Cl⁻+H⁺+HOCl (2)

K=[H⁺][Cl⁻][HOCl]/[Cl₂]=4.2×10⁻⁴(25° C.) (2a)

Also, chlorine can react with chloride in aqueous solution forming trichloride:

Cl₂+Cl⁻→Cl₃⁻ K=0.21(25° C.) (3)

K=[Cl₃]/[Cl⁻][Cl₂]=0.21(25° C.) (3a)

The above equations are known from A. J. Bard at al (Eds. Standard Potentials in Aqueous Solution.; Marcel Dekker, Inc., New York, N.Y., 1985), A. Tang et at (J. Chem. Eng. Data 1985, 30, 189), C. W. Spalding (A.I.Ch.E. Journal 1962, 8, 685) and F. A. Cotton et al (Advanced Inorganic Chemistry-a Comprehensive Text.; Interscience Pubs., New York, 1962).

Since the reduction of Cl₃⁻ has a standard electrode potential, E^{o}=+1.41 V (vs. NHE) which is close to the value for the reduction of chlorine, the electrochemical signal as shown in FIG. 4 may be either Cl₂ or Cl₃⁻, or indeed possibly HOCl. Therefore equations (2a), (3a) were solved to give the equilibrium concentrations of each species in solution. This requires the additional equations (4) to (6) below.

Two of these equations are conservation laws for the initial concentration of H⁺ present in solution (4) before the addition of chlorine.

[H⁺]−[HOCl]=s s=[H]ᵢₙᵢₜᵢₐₗ (4)

and the total concentration of Cl₂ (5):

[Cl₃]+[Cl₂]+[HOCl]=0.059 (5)

This value of 0.059 M is the solubility of chlorine in water, which is reported as 4.22 g L⁻¹ (25° C.) by C. W. Spalding (A.I.Ch.E. Journal 1962, 8, 685).

The third equation is due to the restrictions of electroneutrality of the solution:

s+[H⁺]=[Cl]+[Cl₃]+c c=[Cl]ᵢₙᵢₜᵢₐₗ (6)

The above five equations (2) to (6), were solved to observe the effect of proton and chloride concentrations on the presence of free chlorine. The results are summarised in Table 1.

TABLE 1
Equilibrium Concentrations of Species involved in the Electrochemical
Reduction of Chlorine

| | | | | | | | Peak |
|---|---|---|---|---|---|---|---|
| | | | | | | | Currents/ |
| [H]⁺ᵢₙᵢₜᵢₐₗ | [Cl]⁻ᵢₙᵢₜᵢₐₗ | [H]⁺ | [Cl₂] | [Cl]⁻ | [HOCl] | [Cl₃]⁻ | ×10⁻² A |
| 0.01 | 0 | 0.04 | 0.02 | 0.02 | 0.03 | 0.00 | 0.61 |
| 0.1 | 0 | 0.12 | 0.03 | 0.02 | 0.02 | 0.00 | 0.39 |
| 1 | 0 | 1.01 | 0.04 | 0.01 | 0.01 | 0.00 | 0.45 |
| 0.1 | 0.001 | 0.12 | 0.03 | 0.02 | 0.02 | 0.00 | 1.39 |
| 0.1 | 0.01 | 0.11 | 0.04 | 0.02 | 0.01 | 0.00 | 1.18 |
| 0.1 | 0.1 | 0.10 | 0.05 | 0.10 | 0.00 | 0.01 | 1.19 |
| 0.1 | 1 | 0.10 | 0.04 | 0.99 | 0.00 | 0.01 | 1.15 |
| 0.1 | 2 | 0.10 | 0.04 | 1.98 | 0.00 | 0.01 | 1.06 |
| 0.1 | 3 | 0.10 | 0.03 | 2.98 | 0.00 | 0.02 | 0.94 |

[ ] refers to concentration in mol dm⁻³.

As shown in Table 1, when the chloride concentration is negligible a nitric acid concentration of 0.1M HNO₃ is sufficiently acidic so to render the disproportion reaction (equation 2) insignificant such that HOCl is not formed and needs not be considered. At the same time this means the voltammetric signal is not due to HOCl.

Next, a saturated solution of chlorine in 0.1M HNO₃ was prepared. Using the eppg electrode the response of the chlorine reduction wave was explored as increasing concentrations of chloride were added. It was observed that reductive peak current to decreased and shifted to less negative potentials, from +0.21 V for 1 mM added chloride and +0.54 for 3000 mM added chloride. This suggests that the electroactive species is chlorine and not Cl₃⁻.

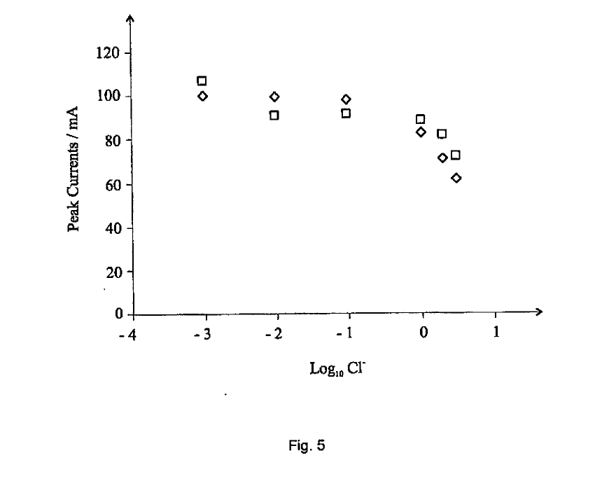

To confirm this, the expected chlorine concentrations were calculated as above for each addition of chloride to the system using the equilibrium constant for the chloride reaction (equation 3a) and a total chlorine concentration calculated from, the known solubility of chlorine (4.22 g L⁻¹ from C. W. Spalding). FIG. 5 shows the expected peak currents found using these calculated chlorine concentrations for increasing chloride concentration using the Randles-Sevcik equation for the irreversible electron transfer case (assuming α=0.5) with a literature diffusion of 1.38×10⁻⁵ cm² s⁻¹ from A. Tang et al. As shown in FIG. 5, these expected peak currents were found to match well with the observed peak currents recorded as a function of added chloride concentration, confirming the assignment of the voltammetric results of the reduction of free chlorine.

The above results suggest that to measure the reduction of chlorine effectively, the solution must be chloride free with a nitric acid concentration of 1 M. Note that a small presence of chloride will effect the chlorine concentration by a significant amount since the trichloride anion is not voltametrically visible (see Table 1). This inference has implications for the lifetime of gas sensors where significant chloride levels could build up, especially if the chloride ion is unlikely to be discharged at the counter electrode. Moreover nitric acid must be present otherwise the disproportionation of chlorine will interfere with the analytical determination.

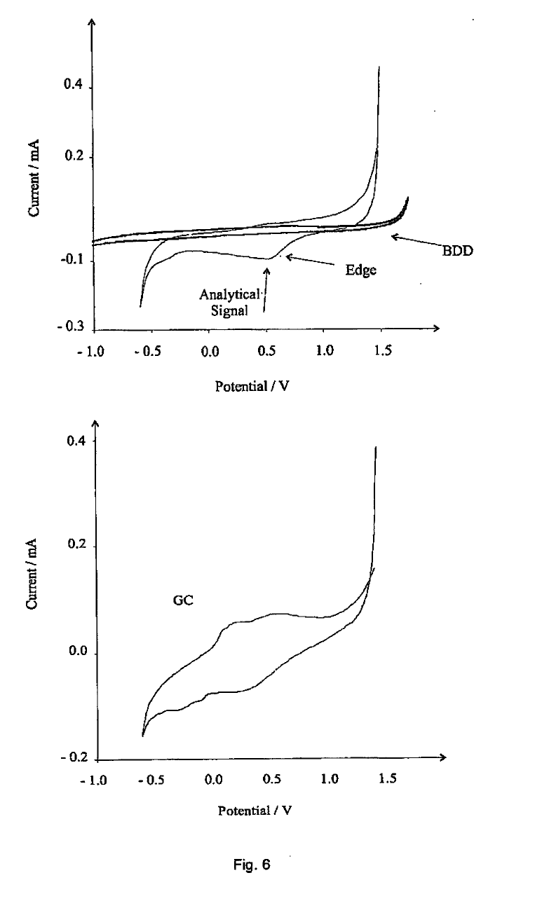

Next, the voltammetric response was investigated with the other different electrode materials which are commercially available. A 1 M nitric acid solution containing a ‘small amount’ (which refers to ca. 80 bubbles) of the chlorine gas released into an aqueous solution from a PTFE tube which has a diameter of 3 mm, (separately for each electrode substrate) was used with GC and BDD electrodes to examine the possible analytical sensing of chlorine. FIG. 6 shows the resulting voltammograms for each electrode material in the above 1 M nitric acid solution.

No significant Faradaic reduction/waves are observed at the BDD in contrast to the behaviour of eppg and GC at this low level of chlorine. A well-defined response is observed at the eppg electrode which can be attributed to edge plane sites serving as active sites for chlorine reduction.

These results show the edge plane pyrolytic graphite can be conveniently and cheaply used for the routine analytical gas sensing of chlorine and, where existing sensors employ graphite electrodes, the edge plane component is critical in facilitating a Faradaic response.

Eppg shows a higher degree of electrochemical reversibility in comparison to that seen with GC, bppg or BDD electrodes. A significant reduction in the overpotential is also observed on the eppg electrode in contrast to the other carbon-based electrode substrates. These results suggest that eppg can be optimally used in the low potential amperometric gas sensing of Cl₂.

Without wishing to be bound by theory, it is believed that sensors with regular graphite electrodes have limited lifetimes because the edge of the graphite (which is the key part of the graphite with regard to sensing) is where intercalation occurs. A sensor with increased amount of edge plane will take longer for the electrode to deteriorate due to intercalation of any ions which happen to be in the electrolyte (for example HSO₄⁻ ions). Eppg may also have desirable signal-to-noise ratio and electrocatalytic activity.

### Example 2

### Detection of NO₂

First, cyclic voltammograms of nitrogen dioxide (99.5%, Aldrich) in a 5.0 M sulphuric acid solution (all solutions were prepared with deionised water of resistivity not less than 18.2 M Ohm cm (Vivendi water systems) were recorded at an eppg electrode. This concentration was chosen since Stetter et al report this for their detection of nitrogen dioxide using a gold working electrode, observing an oxidation wave at +0.2 V (vs. platinum wire); no reduction wave was observed under their conditions.

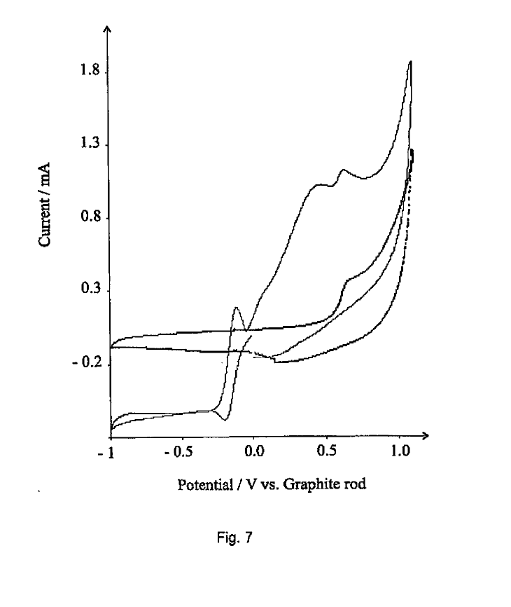

FIG. 7 shows the voltammetric response at the eppg electrode. Clearly a reduction wave is observed at ca. −0.21 V (vs. graphite reference) with an oxidation wave occurring at ca. −0.10 V with a large anodic wave at +0.48 V. For clarity, a voltammogram is shown in the absence of nitrogen dioxide confirming the waves corresponding to the electrochemical reduction and oxidation of nitrogen dioxide. It is observed that the oxidation peak at ca. −0.10 V is only observed when the reduction (at ca. −0.21 V) has occurred.

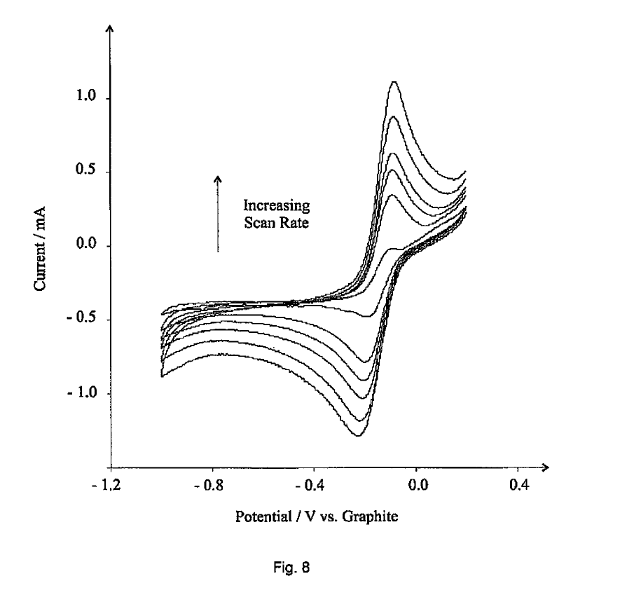

FIG. 8 shows the results when the potential sweep range was reduced to embrace only the redox couple at −021 V which was investigated with a range of scan rates. The peak potential was observed to increase with increasing scan rate indicating a quasi-reversible process. A plot of reduction peak current versus square root of scan rate produced a linear response, indicating a diffusion species rather than an adsorbed one.

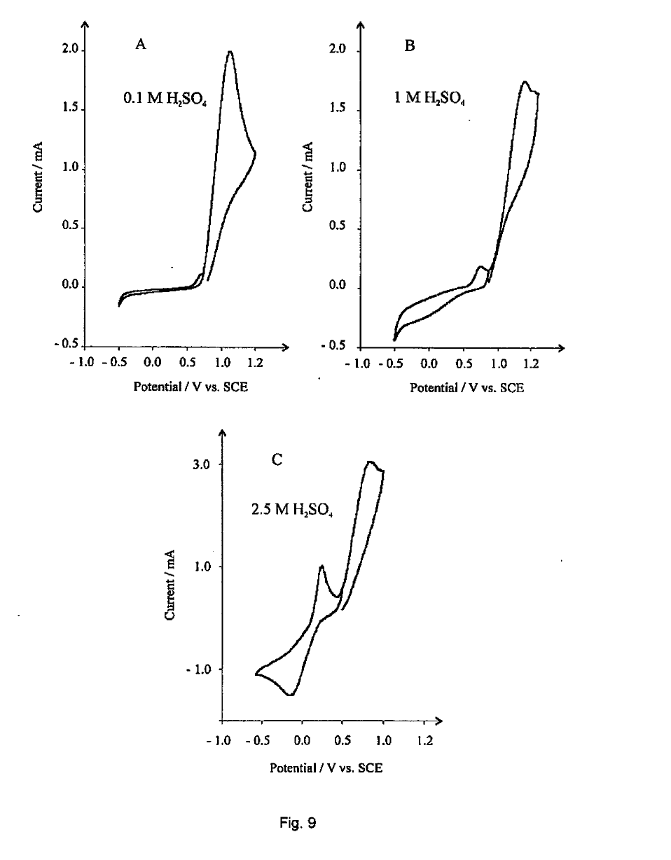

Next, the effect of pH on the voltammetric response was investigated. FIG. 9 shows the voltammetric responses recorded in 0.1, 1.0 and 2.5 M sulphuric acid solutions. At 0.1 M sulphuric acid concentration no reduction wave was observed, but a corresponding oxidation wave is observed at ca. 0.0 V (vs. graphite) along with an oxidation wave at ca. +0.26 V. Also, for 1.0 M sulphuric acid, the reduction wave is absent but with an oxidation wave at +0.098 V and ca. +0.60 V (vs. graphite). However, at 2.5 M sulphuric acid concentration, the quasi-reversible redox couple is evident with a reduction peak at ca. −0.35 V with the corresponding oxidation wave at ca. −0.079 V with another oxidation wave at ca. +0.39 V (all vs. graphite). This dependence on pH suggests that the reduction waves seen at ca. −0.21 V (vs. graphite, +0.53 vs. SCE) may be attributed to the following reaction:

NO₂+e⁻+H⁺→HNO₂

where the process may be kinetically controlled by the rate of protonation so accounting for the lack of signal at higher pH.

The corresponding oxidation wave at ca. −0.10 V (vs. graphite, +0.645 vs. SCE) is:

HNO₂−e⁻−H⁺→NO₂

The oxidation wave at +0.47 V was investigated further via cyclic voltammetry. The variation in scan rate was sought over the range 10 to 200 mVs⁻¹. A plot of peak current vs. square root of scan rate was found to be linear, again consistent with a diffusion controlled process. Tafel analysis of voltammograms, plotted as potential vs. log current produced a value of 268 mV per decade suggesting an electrochemically irreversible process. The oxidation wave at +0.47 V (vs. graphite, +1.21 V vs. SCE) can be attributed to the following:

NO₂−e⁻→NO₂⁺

with the follow up chemistry likely leading to further electron transfer.

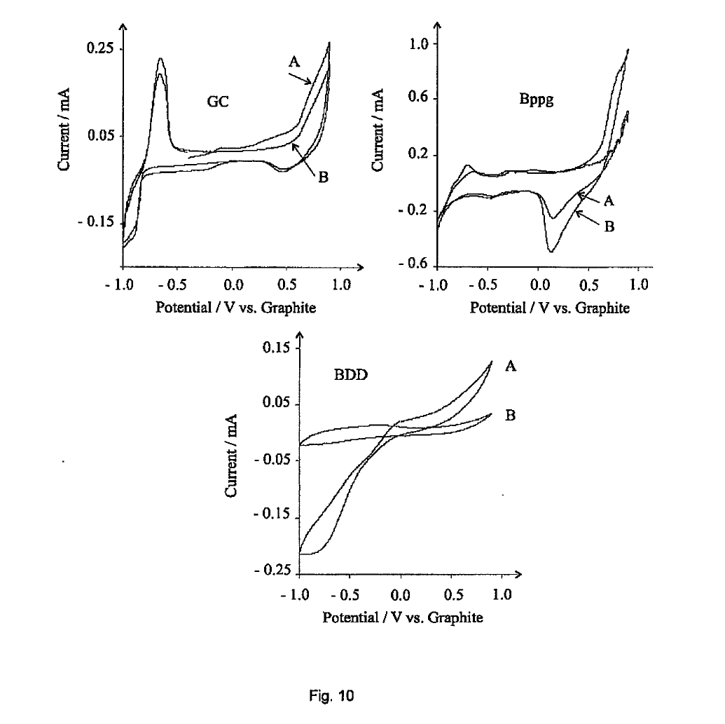

Next, the voltammetric response was investigated with the different electrode materials which are commercially available. A 5.0 M sulphuric acid solution containing nitrogen dioxide (separately for each electrode material) was used with GC, bppg and BDD electrodes. FIG. 10 shows the resulting voltammograms.

For all three electrodes, no Faradaic reduction/oxidation waves were observed. This is in contrast to the results when using eppg electrode.

Without wishing to be bound by theory, it is believed that the edge plane sites act as active sites for nitrogen dioxide reduction/oxidation, suggesting that the eppg can be conveniently used for the sensing of nitrogen dioxide. Where existing sensors employ a graphite electrode, the eppg component may be critical in facilitating a Faradaic response at low pHs.

A reversible redox couple is observed using the eppg and is undetectable using the BDD, bppg and GC electrodes.

The edge plane pyrolytic graphite produces an excellent voltammetric signal in comparison with the other carbon-based electrodes, exhibiting a well-defined, analytically useful voltammetric redox couple, which can be used in the amperometric gas sensing of nitrogen dioxide, and which is absent in other electrode materials.

1. An electrochemical sensor for the detection of a gaseous analyte in a sample, wherein the sensor comprises a working electrode and a counter electrode, and wherein the working electrode comprises edge plane pyrolytic graphite.

2. A sensor according to claim 1, further comprising an electrolyte in contact with the electrodes.

3. A sensor according to claim 1, further comprising a reference electrode.

4. A sensor according to claim 1, wherein the sensor is an amperometric-type gas sensor.

5. A sensor according to claim 1, wherein the edge plane pyrolytic graphite is present in an amount sufficient to provide an electrochemically significant proportion of edge plane sites.

6. A sensor according to claim 1, wherein the working electrode comprises a mixture of edge plane pyrolytic graphite and basal plane pyrolytic graphite.

7. A sensor according to claim 6, wherein the amount of edge plane pyrolitic graphite is greater than that present in regular graphite.

8. A sensor according to claim 7, wherein the amount of edge plane pyrolitic graphite is about 50% of the total amount of graphite.

9. A sensor according to claim 1, wherein the working electrode comprises an aligned single crystal of edge plane pyrolytic graphite.

10. A sensor according to claim 1, wherein the working electrode is such that it undergoes a redox reaction upon contact with the analyte.

11. A sensor according to claim 1, further comprising means for measuring the response of the working electrode to the analyte.

12. A sensor according to claim 1, further comprising an inlet and optionally an outlet for a sample.

13. A sensor according to claim 12, further comprising a filter positioned between the inlet and the working electrode.

14. A sensor according to claim 12, further comprising a porous membrane positioned between the inlet and the working electrode, wherein the membrane allows diffusion of the analyte to the working electrode.

15. A sensor according to claim 14, wherein the working electrode is present on a surface of the membrane.

16. A method of detecting a gaseous analyte in a sample, which comprises the steps of contacting the sample with a working electrode of an electrochemical sensor of claim 1 and determining the electrochemical response of the working electrode to the sample.

17. A method according to claim 16, wherein a constant potential is applied across the electrodes and the response determined.

18. A method according to claim 16, wherein the amperometric response of the working electrode is determined.

19. A method according to claim 16, wherein the sample is filtered prior to contacting with the working electrode.

20. A method according to claim 16, wherein the analyte is nitrogen dioxide, chlorine, sulphur dioxide, hydrogen, hydrazine, arsine, nitrogen monoxide, a hydrocarbon, oxygen, ozone, carbon monoxide, carbon dioxide, hydrogen sulphide, methane or carbon disulphide.

21. A method according to claim 20, wherein the analyte is nitrogen dioxide.

22. A method according to claim 16, wherein the electromechanical sensor further comprises an electrolyte in contact with the electrodes.

23. A working electrode for an electrochemical gas sensor, wherein the electrode comprises edge plane pyrolytic graphite.

24. An electrode according to claim 23, wherein the edge plane pyrolytic graphite is present in an amount sufficient to provide an electrochemically significant proportion of edge plane sites.

25. Use of a working electrode for the detection of a gaseous analyte, wherein the electrode comprises edge plane pyrolytic graphite.

26. Use according to claim 25, wherein the edge plane pyrolytic graphite is present in an amount sufficient to provide an electrochemically significant proportion of edge plane sites.

27. Use according to claim 25, wherein the analyte is nitrogen dioxide, chlorine, sulphur dioxide, hydrogen, hydrazine, arsine, nitrogen monoxide, a hydrocarbon, oxygen, ozone, carbon monoxide, carbon dioxide, hydrogen sulphide, methane or carbon disulphide.

28. Use according to claim 27, wherein the analyte is nitrogen dioxide.
